(19) United States
(12) Patent Application Publication
(10) Pub. No.: US 2025/0074806 A1
(43) Pub. Date: Mar. 6, 2025

(54) PRODUCED WATER DESALINATION WITH FRACTIONAL FREEZE CYCLES

(71) Applicant: Transmissive Water Services LLC, Midland, TX (US)

(72) Inventors: Robert Crain, Midland, TX (US); Adrianne Lopez, Midland, TX (US)

(21) Appl. No.: 18/817,958

(22) Filed: Aug. 28, 2024

Related U.S. Application Data
(60) Provisional application No. 63/579,592, filed on Aug. 30, 2023.

(51) Int. Cl. C02F 9/00; B01D 61/02; B01D 61/04; C02F 1/22; C02F 1/44; C02F 1/52; C02F 101/32; C02F 103/10

(52) U.S. Cl. CPC C02F 9/00; B01D 61/025; B01D 61/04; B01D 2311/04; C02F 1/22; C02F 1/441; C02F 1/5236; C02F 2101/32; C02F 2103/10; C02F 2301/08

(57) ABSTRACT

The present disclosure presents desalination systems and related methods. One such method comprises receiving produced water brine; pre-treating the produced water brine to at least remove solids from the produced water brine; passing the pre-treated produced water brine through a freeze desalination equipment, wherein the pre-treated produced water is subject to freezing temperatures that are within 5 degrees Fahrenheit of the pre-treated produced water's freezing point; and/or separating frozen pre-treated produced water from unfrozen pre-treated produced water, wherein the frozen pre-treated produced water has a saline concentration that is reduced after being processed through the freeze desalination equipment.

### CROSS-REFERENCE TO RELATED APPLICATION

This application claims priority to co-pending U.S. provisional application entitled, “Produced Water Desalination with Fractional Freeze Cycles,” having application No. 63/579,592, filed Aug. 30, 2024, which is entirely incorporated herein by reference.

### BACKGROUND

In many cases, produced water is generated in the oil and gas extraction process at rates containing significantly higher water than oil volumes. Such rates are expressed as a ratio of barrels of water to oil, where this water may contain high solids content, high salinity, oil, and bacteria making it unsuitable for many uses outside of oil and gas without extensive treatment. Accordingly, in order to introduce this water into non-oil and gas applications, desalination of the produced water brine along with other contaminant removal is required. This treatment can be cost prohibitive depending on desired future use and most often, due to costs, results in the produced water being disposed of via saltwater disposal wells (SWDs) as opposed to being treated and used in other operations. As an example, the quantity of produced water generated in the Permian basin alone is approximately 10-11 million barrels daily, which is about 440 million gallons of water that is not currently being utilized outside of the oil and gas industry. Thus, there is a need for an efficient low-cost desalination method that can create a new source of clean water with a multitude of alternative uses.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a graph for freezing temperature in relation to starting total dissolved solids (TDS).

FIG. 2 shows an exemplary fractional freezing desalination treatment process in accordance with various embodiments of the present disclosure.

FIG. 3 shows a high-level overview of the various stages of fractional freezing desalination treatment process in accordance with various embodiments of the present disclosure.

FIG. 4A shows rechiller equipment in accordance with various embodiments of the present disclosure.

FIG. 4B shows a cubed ice maker in accordance with various embodiments of the present disclosure.

FIG. 4C depicts dendritic crystal growth that occurs in low temp-fast freezing environments.

FIG. 4D depicts slow layered ice formation in accordance with the present disclosure.

FIG. 5 shows a fractional freeze desalination treatment process that is separated or staged by cycles in accordance with various embodiments of the present disclosure.

### DETAILED DESCRIPTION

The present disclosure describes various embodiments of fractional freeze desalination systems, apparatuses, and methods. In particular, fractional freeze desalination is a low-cost method of desalination that is tailorable to the desired water quality required for its intended use. An exemplary fractional freeze desalination process of the present disclosure utilizes freezing fresh and brackish water from an incoming high-salinity brine stream at a lower energy consumption than traditional desalination methods.

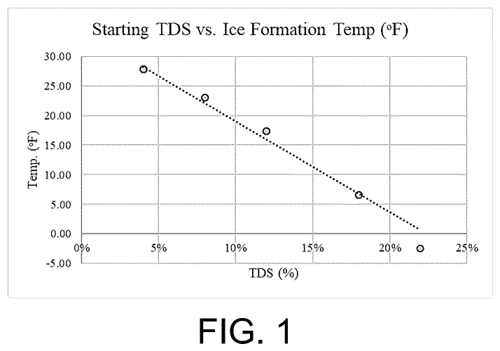

An exemplary process of produced water desalination using fractional freezing involves processing produced water brine through a multi-pass chiller system to enable freezing under selected temperature and pressure conditions. This process reduces the salt content in the ice formation and concentrates the salts and other contaminants in the reject brine. The multi-pass function of the chiller system allows for processed ice to be reprocessed, further reducing the salinity levels until the desired concentration of salt is reached. Given that salinity lowers the freezing point of water, when the water is frozen under select temperatures and pressures slightly above the freezing point of the entire solution, the ice formed has a lower salt concentration than the liquid brine remaining, as illustrated in FIG. 1, which shows a graph for freezing temperature in relation to starting total dissolved solids (TDS). Correspondingly, the leftover concentrated brine can be processed further using controlled freeze-thaw cycles or disposed of responsibly.

An exemplary fractional freezing desalination process of the present disclosure can be performed on brines of varying water quality and salinity to decrease salinity by up to 60% per cycle while capturing 60-70% of the starting volume per pass. In various embodiments, the exemplary process performs in an optimal manner on high salinity water, as there is a large delta in the freezing point of high salinity brine and fresh water. When the freezing point delta is within 5-10° F., ice formation occurs throughout the entire solution to create a slush that necessitates an alternative dewatering process.

The fractional freezing desalination process can be performed on the concentrated brine as well as the reduced-salinity melted ice until the ideal volume has been recovered and the desired salinity has been met. This low-cost process of fractional freeze distillation can be utilized to recover clean water from produced water brine that would otherwise be sent to disposal.

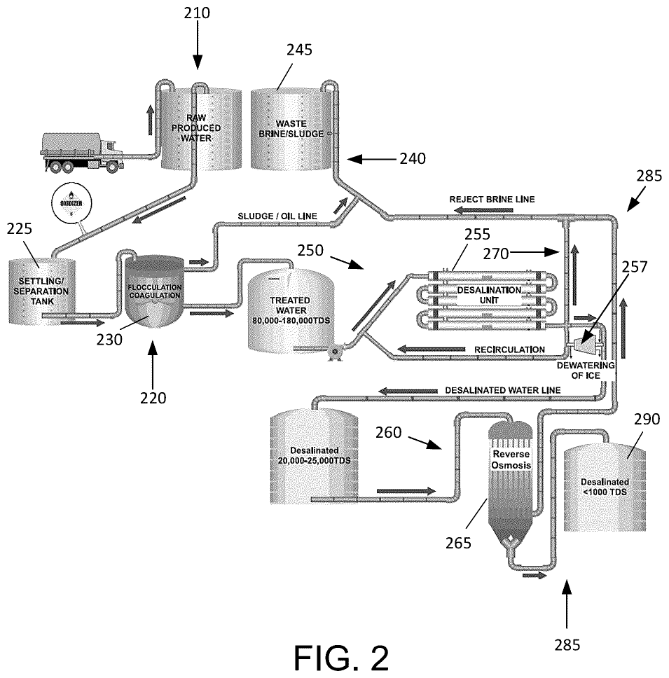

Referring now to FIG. 2, the figure shows an exemplary fractional freezing desalination treatment process from start to finish, starting with the delivery of raw produced water (210). The water is then chemically oxidized and sent (220) to settling tank(s) 225 that increase reaction time in order to enhance oil separation and settling of solids. Oil will naturally float to the top of the tank 225 while solids will gravitate towards the bottom. Fluid can then be pulled from the middle of the tank 225 with reduced oil and solids content. This increases the efficiency of the pre-treatment tank(s) 230 used for flocculation, coagulation, and separation. The sludge is sent (240) to the waste tank 245, and the treated water is sent (250) to a freeze desalination equipment or unit 255. In various embodiments, an exemplary freeze desalination process can include a combination of rechiller equipment (which can be cooled to form slush ice) and ice maker(s) (e.g., cubed ice makers configured to make cubed ice), where multiple passes through the freeze desalination equipment may be performed. From the freeze desalination equipment 255, the desalinated cubed or slush ice is dewatered (257) and sent (260) to a RO (Reverse Osmosis) stage/equipment 265 for further processing, and the brine is sent (270) to the waste tank 245. The RO acts to desalinate the water to whatever the required TDS (Total Dissolved Solids) concentration value is and is then stored (280) in a desalinated water tank 290. The reject brine will then be sent (285) to the waste tank 245. In various embodiments, the desalinated water is then passed through a granular activated carbon media filter and disinfected via chemical or ultraviolet (UV) processes depending on the final desired use.

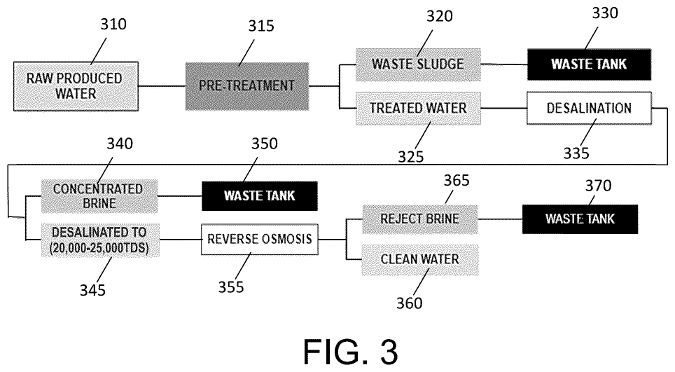

Accordingly, FIG. 3 shows a high-level overview of the various stages of fractional freezing desalination treatment process. As such, the process starts with raw produced water (310) and a pre-treatment (315) of the raw produced water to produce waste sludge (320) and treated water (325). The waste sludge is removed to a waste tank (330) and the treated water undergoes desalination (335) which produces concentrated brine (340) and desalinated water (345) (e.g., to 10,000 to 15,000 parts per million (ppm) TDS), where multiple passes through a freeze desalination equipment or unit may be performed. Accordingly, the concentrated brine is removed to a waste tank (350) and the desalinated water can optionally undergo a reverse osmosis treatment (355), resulting in clean water (360) and reject brine (365) that is removed to the waste tank (370). Concentrated brine (340) from the freeze desalination process can also be processed multiple times to extract lower salinity water until the solution reaches its saturation point. In various embodiments, concentrated brine may undergo freeze desalination via a cubed ice maker and/or slush generator (using the rechiller equipment) based on the salinity.

As shown in FIGS. 2 and 3, various embodiments of the present disclosure find it beneficial to pre-treat the produced water prior to processing via fractional freeze thaw cycles, since produced water contains various heavy metals, salts, gases, and hydrocarbons that can reduce the effectiveness of the freeze desalination equipment, cause corrosion or scale, and lead to expensive cleaning and downtime.

For instance, produced water typically goes through an enhanced oil separation facility prior to being sent for disposal or recycling to recover any remaining oil present in the stream. TPH (total petroleum & hydrocarbons) concentrations post enhanced oil separation range from 100-5,000 ppm. Correspondingly, fractional freeze distillation takes place at temperatures ranging from −5° F.-25° F. which will cause oil or grease to solidify on surfaces or become suspended at the surface of the fluid. If TPH is detected greater than 15 ppm, it will decrease efficiency of the freeze desalination equipment and create sludge buildup within the equipment. For this reason, in various embodiments, oil is reduced to sub 15 ppm prior to entering the freeze desalination equipment.

Further, oxidation of produced water can be performed to oxidize toxic and corrosive iron, enhance oil separation, and disinfection. The oxidation of dissolved iron causes iron oxide particles to precipitate so they can be removed via filtration or coagulation along with leftover hydrocarbons and sediment present in the raw produced water. Produced water also contains harmful acid-producing and sulfate-reducing bacteria, as well as toxic hydrogen sulfide. These bacteria are not killed during the fractional freeze-thaw cycles and therefore must be removed beforehand via chemical disinfection. Oxidation has also been proven to breakdown some chemicals leftover from oil extraction operations. Chemical residues can interfere with the freezing temperature of the water, the removal efficiency for certain elements and molecules, and foul RO membranes; therefore, in various embodiments, the pre-treatment process attempts to remove and degrade as many leftover chemicals as possible.

In various embodiments, pre-treatment can also include a coagulation process where solids present post-oxidation are coagulated using a coagulant (e.g., a cationic aluminum-based coagulant) to suspend and attract negatively charged particles in water for easy separation or filtration. This also improves the turbidity of the water making it easier to treat and less reactive to treatment chemicals or membranes. Reducing the turbidity by removing solids also reduces the risk of clogging, scale formation, and inclusions during ice formation.

During pre-treatment, a flocculant can also be added to the water to create a suspended floc of coagulated particles that can be skimmed off the top or drained from the bottom. This process can also be enhanced by using dissolved air flotation to inject tiny microbubbles that will bind to the floc and float it to the top quicker. Once the floc has been removed from the water, it can be further processed through fractional freeze desalination equipment.

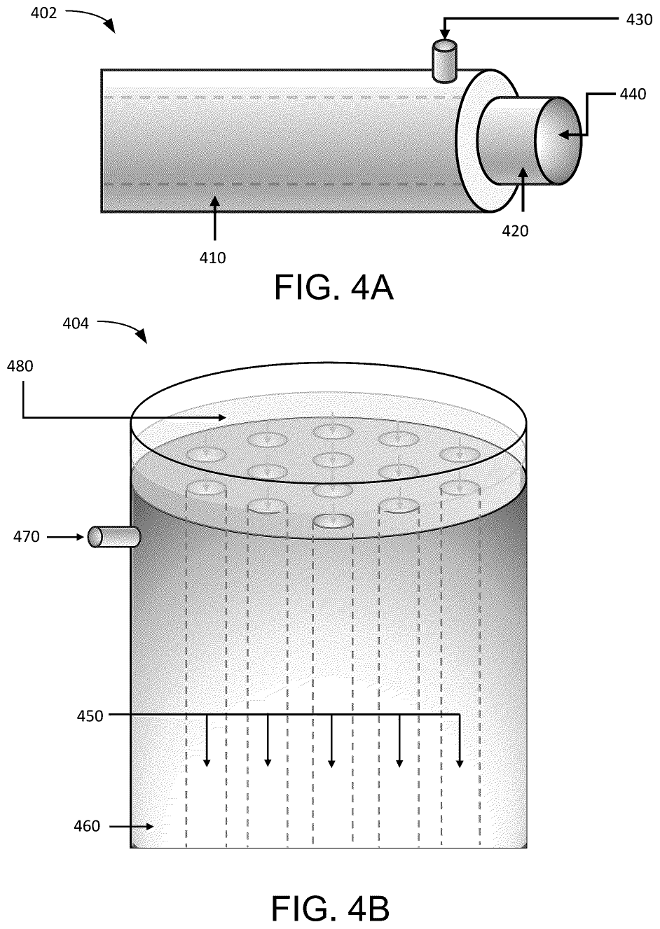

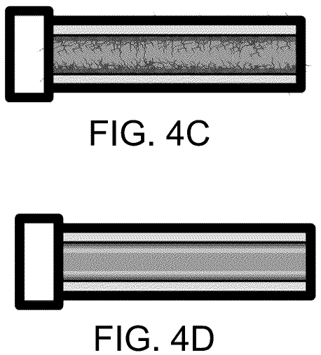

In various embodiments, as shown in FIG. 4A, fractional freeze equipment includes rechiller equipment 402 of stainless steel tubing 420, surrounded by a second layer of stainless-steel tubing 410 that is filled with refrigerant that can be temperature controlled within 0.2° F. Correspondingly, in various embodiments, the rechiller equipment 402 provides a refrigerant inlet 430 for introducing refrigerant and a water inlet 440 for introducing brine water within the confines of the rechiller equipment.

In various embodiments, as shown in FIG. 4B, fractional freeze equipment further includes a cubed ice maker 404 that allows water to gravity flow through vertical tubes 450 surrounded by a large outer housing 460 that is filled with refrigerant causing ice to form within the tubes B10 that can be removed and broken into small ice cubes. Correspondingly, in various embodiments, the ice maker 404 provides a refrigerant inlet 470 for introducing refrigerant and a water inlet 480 for introducing brine water within the confines of the ice maker.

When utilizing the rechiller equipment 402 to make slush, the brine water (from a high brine holding tank) is processed through the inner stainless-steel tubing 420, at a high velocity, and does not come into contact with the refrigerant that is in the outer pipe 410 surrounding it. The temperature is decreased to the freezing point of the entire solution and small individual ice crystals begin to form throughout the entire solution upon entering the rechiller therefore creating a slush of brine and pure water ice crystals. This slush solution must remain in motion until it is sent to the dewatering unit in order to prevent the crystals from interlocking with each other and trapping the surrounding brine within.

When using the ice maker 402 to make solid ice, ice will begin to precipitate on the inner surface of the tubing 440 as the temperature of the refrigerant is lowered. The ice formed on the surface is crystallized at high velocity which has been shown to decrease the amount of salt that is captured within the crystal structure of the ice by not allowing any salt to settle or accumulate on the nucleation surface during ice growth. The ice is formed at temperatures 5-10° F. below the established freezing point of the beginning stream based on its salinity and TDS concentration.

Freezing at supercooled temperatures has been shown to increase salt inclusions within the ice crystal structure by increasing crystallization speed and not allowing the water molecules to settle into a crystal lattice structure slowly. If the crystal structure is formed quickly, ice dendrites can extend rapidly in different directions trapping brine pockets and salt molecules within the structure, as illustrated in FIG. 4C (showing dendritic crystal growth that occurs in low temp-fast freezing environments). The disorderly structure of the H₂O molecules allows many spaces for impurities and brine pockets to occur during ice formation. Freezing at a higher temperature (within 5° F. of the relative freezing point) allows for a slower more controlled growth of the ice crystals on the inner walls, as illustrated in FIG. 4D (showing slow layered ice formation much like a hailstone). The ice forms from the H₂O molecules arranging themselves in crystalline sheets making it more difficult for impurities to be included in crystal lattice structure. This technique combined with high velocity fluid cycling, which is essentially rinsing the nucleation sites for ice crystal growth, is optimally efficient in reducing salinity per cycle.

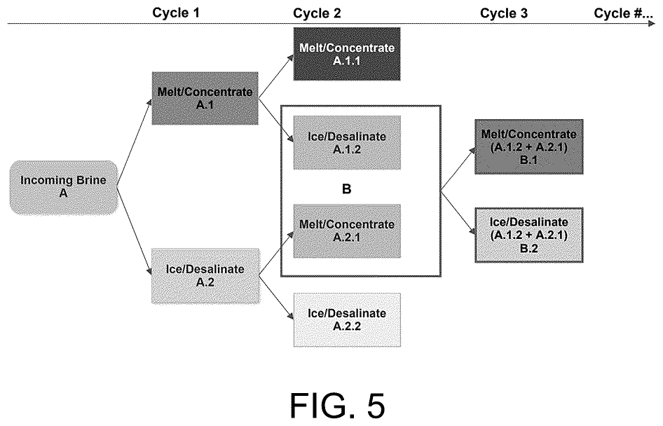

When the ice reaches a desired thickness indicated by an increase in pressure (due to a decrease in inner diameter), the remaining unfrozen brine is drained from the system, and the inlet is changed to a desalinated brine or freshwater. If the ice layer gets too thick, the ice layer will act as an insulator to the brine and not allow any further cooling by the coolant in the outer tube. The desalinated brine is heated prior to injection to melt the ice from the inside of the pipe and flush into the desalinated holding tank. In order to initiate to a subsequent desalination process, this process can be repeated, as illustrated in FIG. 5: (1) with the rejected concentrated brine, or (2) with the melted desalinated brine to further reduce salinity. Based on the starting concentration of the brine entering the fractional freeze desalination equipment, the water can require multiple passes through the desalination equipment (e.g., 1-3 passes) to achieve the desired salinity post ice separation.

As discussed with respect to FIG. 4A, when using the rechiller equipment to make slush, the temperature is decreased to the freezing point of the entire solution and small individual ice crystals begin to form throughout the entire solution upon entering the rechiller therefore creating a slush of brine and pure water ice crystals. This slush solution must remain in motion until it is sent to the dewatering unit in order to prevent the crystals from interlocking with each other and trapping the surrounding brine within. The slush is sent directly to a dewatering unit to separate the ice crystals from the brine solution.

Referring back to FIG. 4B. when using the cubed ice maker 404 comprised of multiple smaller vertical tubes 450 within a large, refrigerated housing 460, water is cycled through the multiple small vertical tubes 450 (e.g., 1-2 inches in diameter) and allowed to flow through while depositing lower salinity ice to the inner walls of each tube. When the tubes 450 are all completely filled with ice as detected by the flow rate entering and leaving the tubes, the refrigerant temperature is increased and the ice is released from the tubes 450 to fall and break into small pieces. The fluid remaining in the inlet storage tank 250 can also be directed to the dewatering system to extract ice crystals that did not form into ice cubes during the freeze process.

In particular, FIG. 5 shows a fractional freeze desalination treatment process that is separated or staged by cycle. Here, incoming Brine A will be separated into ice (A.2) and melt/concentrate (A.1). A.2 can be further processed to A.2.1 (melt) and A.2.2 (ice). A.1 can be further processed to A.1.1 (melt) and A.1.2 (ice). A.1.2 (ice) and A.2.1 (melt) will then have similar salinities and can be blended to form B and reprocessed again to generate B.1 (melt), and B.2 (ice).

As such, multiple units can be run in series to simultaneously process incoming produced water brine, concentrated produced water brine (melt water from initial fractional freeze thaw cycle), desalinated produced water brine (ice from original fractional frees thaw cycle), along with their daughter brines developed during further processing.

The foregoing process is efficient on water containing TDS in excess of 25,000 ppm. In general, RO is an efficient dissolved solids removal method for water up to 25,000 ppm TDS and can recover 60-70% of the inlet stream with up to a 90% solids rejection rate. Water containing TDS in excess of 25,000 ppm is unsuitable for desalination with RO (reverse osmosis) due to efficiency decline. High concentrations of dissolved solids cause membrane fouling and recovers only 20-30% of the inlet volume. There are some RO membranes on the market that are manufactured to intake 25,000-30,000 TDS water (depending on the composition of solids dissolved); however, these membranes are not economical, and the frequent replacement of membranes makes this TDS range more suited for fractional freeze desalination. When the water has been desalinated to a quality below 25,000 ppm TDS, the water can be optionally processed using RO to meet desired conditions. The finished solids concentration, post RO, is customizable based on the desired final use.

In brief, various embodiments of the present disclosure present systems and methods for a fractional freeze distillation treatment using a pre-treated produced water brine through tailored freeze thaw cycles under set temperature and pressure conditions are efficient techniques for desalinating brine to a customizable finished quality. In accordance with the present disclosure, freezing at a higher temperature allows for solid ice to form slowly, therefore creating a more orderly crystalline ice structure that will naturally exclude impurities from the crystal lattice structure. Therefore, freezing to a chilled surface from a high velocity fluid decreases inclusions and brine pockets within the ice during formation. This process is more efficient of water above 25,000 ppm TDS (majority salinity) because, below 25,000 ppm TDS, the freezing point is too close to that of freshwater to efficiently freeze freshwater ice from a Brackish solution. Thus, fractional freeze desalination reduces TDS and salinity by slowly freezing freshwater ice from a brine solution or creating a slush solution consisting of many small ice crystals within a brine solution that can be mechanically separated. TDS and salinity can be reduced anywhere from 60-80% per cycle.

With respect to the present disclosure, it is to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

Unless defined otherwise, all technical and scientific terms used herein have the same meanings as commonly understood by one of skill in the art to which the disclosed invention belongs. Those skilled in the art will recognize, or be able to ascertain using no more than routine experimentation, many equivalents to the specific embodiments described herein. Such equivalents are intended to be encompassed by the following claims.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A desalination method comprising:
receiving produced water brine;
pre-treating the produced water brine to at least remove solids from the produced water brine;
passing the pre-treated produced water brine through a freeze desalination equipment, wherein the pre-treated produced water is subject to freezing temperatures that are within 5 degrees Fahrenheit of the pre-treated produced water's freezing point; and
separating frozen pre-treated produced water from unfrozen pre-treated produced water, wherein the frozen pre-treated produced water has a saline concentration that is reduced after being processed through the freeze desalination equipment.

2. The method of claim 1, further comprising reintroducing the frozen pre-treated produced water through the freeze desalination equipment for a multiple pass, wherein ice that forms during the multiple pass through the freeze desalination equipment has a saline concentration that is reduced after being processed through the freeze desalination equipment.

3. The method of claim 1, further comprising reintroducing the unfrozen pre-treated produced water through the freeze desalination equipment for a multiple pass, wherein ice that forms during the multiple pass through the freeze desalination equipment has a saline concentration that is reduced after being processed through the freeze desalination equipment.

4. The method of claim 1, wherein the unfrozen pre-treated produced water is reintroduced between 1 to 3 times through the freeze desalination equipment.

5. The method of claim 1, further comprising:
melting the frozen pre-treated produced water; and
processing, using reverse osmosis, the melted pre-treated produced water to further remove dissolved solids.

6. The method of claim 1, wherein reverse osmosis processing is performed until a predefined total dissolved solids parts per million (ppm) value is achieved.

7. The method of claim 1, wherein a total petroleum and hydrocarbons concentration of the pre-treated produced water brine is less than 15 ppm before being allowed to pass to the freeze desalination equipment.

8. The method of claim 1, wherein a total dissolved solids ppm value for the pre-treated produced water brine is greater than 25,000 ppm before being allowed to pass to the freeze desalination equipment.

9. The method of claim 1, wherein the pre-treatment of the produced water brine comprises a flocculation process, a coagulation process, and an oil separation process.

10. The method of claim 1, wherein the freeze desalination equipment comprises rechiller equipment having stainless steel tubing surrounded by a second layer of stainless-steel tubing that is filled with refrigerant, the method further comprising using the rechiller equipment to produce solid ice and unfrozen brine.

11. The method of claim 1, wherein the freeze desalination equipment comprises rechiller equipment having stainless steel tubing surrounded by a second layer of stainless-steel tubing that is filled with refrigerant, the method further comprising using the rechiller equipment to produce a slush solution of ice crystals within an unfrozen brine stream.

12. The method of claim 1, wherein the freeze desalination equipment comprises a cubed ice maker having stainless steel tubs surrounded by a larger stainless steel tube that is filled with refrigerant, the method further comprising using the freeze desalination equipment to produce solid ice having a lower salinity than that of the pre-treated produced water brine the ice was frozen from.

13. A fractional freeze desalination system comprising:
a settling tank;
a pre-treatment tank; and
a freeze desalination equipment;
wherein the settling tank is configured to separate oil and solids from raw produced water brine and pass the separated produced water brine to the pre-treatment tank, the pre-treatment tank being configured to treat the passed water brine via flocculation, coagulation, and separation of solids from the passed water brine and send the treated water brine to the freeze desalination equipment, the freeze desalination equipment being configured to subject the treated water brine to freezing temperatures that are within 5 degrees Fahrenheit of the treated water brine's freezing point and to separate frozen treated water brine from unfrozen treated water brine, wherein the separated frozen treated water brine has a saline concentration that is reduced after being processed through the freeze desalination equipment.

14. The system of claim 13, further comprising a waste tank that is configured to receive oil and solids from the settling tank, solids from the pre-treatment tank, and unfrozen treated water brine from the freeze desalination equipment.

15. The system of claim 13, further comprising reverse osmosis equipment that is configured to perform reverse osmosis treatment of desalinated water from the desalination equipment.

16. The system of claim 13, wherein the freeze desalination equipment comprises a combination of rechiller equipment and an ice maker.

17. The system of claim 16, wherein the rechiller equipment comprises stainless steel tubing, surrounded by a second layer of stainless-steel tubing that is filled with refrigerant that can be temperature controlled within 0.2° F., and the ice maker comprises vertical tubes surrounded by an outer housing that is filled with refrigerant causing ice to form within the vertical tubes.

18. The system of claim 16, wherein the rechiller equipment comprises stainless steel tubing, surrounded by a second layer of stainless-steel tubing that is filled with refrigerant that can be temperature controlled within 0.2° F. and is configured to to produce a slush solution of ice crystals within an unfrozen brine stream.

19. The system of claim 13, wherein the unfrozen treated water brine is reintroduced between 1 to 3 times through the freeze desalination equipment.

20. The system of claim 13, wherein the unfrozen pre-treated water brine is reintroduced at least 2 times through the freeze desalination equipment.
